(19) United States
(12) Patent Application Publication
(10) Pub. No.: US 2011/0290567 A1
(43) Pub. Date: Dec. 1, 2011

(54) Method And System To Determine Need For Dimensional Weighing

(75) Inventors: Dana Waggoner, Springfield, OH (US); Jon Hayes, Powell, OH (US); Barry McDonald, Galena, OH (US)

(73) Assignee: Mettler-Toledo, Inc., Columbus, OH (US)

(21) Appl. No.: 12/791,010

(22) Filed: Jun. 1, 2010

(51) Int. Cl. G01G 19/08; G06F 15/00; G01G 9/00

(52) U.S. Cl. 177/1; 177/25.13; 177/136

(57) ABSTRACT

A system and method for assisting a party (e.g., a freight carrier) in determining whether dimensional weight or actual weight should be used for shipping particular freight. A weighing device may be associated with a forklift, and may also include a DIM comparator in association with the forklift. The DIM comparator may have an input and a display of information, and may also include a CPU unit for storing and processing data. The DIM comparator may allow an operator to input various data through selectable menus and tables. The DIM comparator then determines a theoretical dimensional weight of the freight and compares it to the actual weight as measured by the weighing device associated with the forklift. This comparison is then displayed to the operator and a prompt is provided if a dimensional weight should be determined.

### TECHNICAL FIELD

Exemplary embodiments of the invention described herein relate generally to the packaging and shipping of freight. More particularly, exemplary embodiments of the invention described herein relate to increasing the efficiency of freight shipment and packaging.

### BACKGROUND AND SUMMARY OF THE INVENTION

All cargo space involved in transporting freight has physical limits based on the volume of the freight and its weight. Each type of shipping container (e.g., trailer, train, plane, etc.) typically also has a limit with regard to the amount of freight that can be transported thereby. In recognition of these variables, many freight carriers worldwide have adopted dimensional weight (“DIM weight”) as a standard to calculate shipping charges for light density freight.

DIM weight, also known as Volumetric or Cubed weight, is a calculation of a theoretical weight of a package. This theoretical weight is the weight of the package at a minimum density chosen by the freight carrier. If the package is below this minimum density, then the actual weight is irrelevant as the freight carrier will charge for the volume of the package as if it was of the chosen density (what the package would weigh at the minimum density). Furthermore, the volume (e.g., in cubic inches, cubic feet, cubic meters, etc.) used to calculate the DIM weight may not be absolutely representative of the true package volume. Rather, the freight carrier will measure the longest dimension in each of the three axes (X, Y, and Z) and use these measurements and a dimensional factor to determine the package volume. Thus, the DIM weight is calculated as (Length x Width x Height)/(Dimensional Factor). The measurements can be made in inches or centimeters, but the appropriate dimensional factor must also be applied. If the package is a cube, then the calculated volume will be equal to the true volume of the package. However, if the package is not a cube, then the calculated volume will be more than the true volume of the package.

The DIM weight is applied to freight when the actual density thereof is less than the minimum density represented by the chosen factor. The factor may differ based upon different shipment modes (e.g., international or domestic) or based upon the contents of the freight. The factor may also differ between different customers, depending on value, or for other business reasons.

To determine whether the DIM weight or the actual scale weight produces the most desirable shipping charge, freight is traditionally weighed as well as measured. This has generally been accomplished through a multi-step process whereby each piece of freight is weighed on a floor or forklift scale and then measured manually or by a dimensioner to obtain its volume. The volume of the freight is then used to determine the DIM weight, which is compared to the freight's actual scale weight. If the freight's DIM weight exceeds its actual scale weight, then the DIM weight will be used when calculating shipping charges.

While such a multi-step process functions to determine which DIM weight or actual scale weight yields the most desirable shipping charge, it can be easily understood that such a system and method is time consuming and prone to human error. That is, even if the density of a particular piece of freight is above the minimum density selected by the freight carrier and will thus be subject to shipping charges based upon its actual scale weight, the dimensions of that piece of freight are often measured nonetheless.

This adds an additional, and frequently unnecessary, step to the transportation of each piece of freight whose dimensions do not need to be measured because shipping charges for that piece of freight will be based upon the its actual scale weight. Such an inconvenience might seem insignificant in the case of a single piece of freight; however, when the multitude of freight loads that must be transported and measured in this manner are considered, it can be understood that such a method is highly inefficient and increases a freight carrier's labor and operating costs.

Therefore, it is desirable to overcome the shortcomings of the traditional methods of determining the appropriate freight weight for use in the calculation of shipping charges, as described above.

### SUMMARY OF THE GENERAL INVENTIVE CONCEPT

Exemplary embodiments of the inventive concept are based upon the recognition that in the freight carrier industry determining whether dimensional weight or actual weight should be used for a particular piece or pieces of freight may result in increased revenue. Exemplary embodiments described herein provide a system and method for accurately determining whether time should be spent obtaining a dimensional weight for a particular piece of freight. Embodiments of the present invention minimize the potential for human error in the process and increase efficiency in the loading process.

Generally, the exemplary embodiments described herein provide a weighing device associated with a forklift, and may also include a DIM comparator in association with the forklift. The DIM comparator may have an input and a display of information, and may also include a CPU unit for storing and processing data. The DIM comparator may allow an operator to input data related to maximum shipping device (e.g., pallet) capacity, percent of maximum shipping device capacity used, shipping factors values, and a threshold percentage, through selectable menus and tables.

Based upon operator input, the DIM comparator then determines a theoretical dimensional weight of the freight and compares it to the actual weight as measured by the weighing device associated with the forklift. The DIM comparator then displays this comparison to the operator and provides a prompt as to whether a dimensional weight should be determined. If the actual weight of the freight is greater than the theoretical dimensional weight then determination of a dimensional weight is unnecessary. If the actual weight is less than the theoretical dimensional weight, then a determination of dimensional weight to determine shipping costs is advisable.

### BRIEF DESCRIPTION OF THE DRAWINGS

In addition to the features mentioned above, other aspects of the inventive concept will be readily apparent from the following descriptions of the drawings and exemplary embodiments, therein like reference numerals across the several views refer to identical or equivalent features, and wherein:

FIG. 1 is a diagram illustrating an exemplary embodiment of a method for using an exemplary DIM weight comparator of the present invention;

FIG. 2 is a perspective view illustrating an exemplary forklift equipped for weighing and comparing actual weight to DIM weight using a DIM weight comparator;

FIG. 3 is a diagram illustrating an exemplary configuration procedure of the DIM weight comparator;

FIG. 4 is an illustration of an exemplary pallet capacity selection screen of the DIM weight comparator;

FIG. 5 is an illustration of an exemplary shipping factor setup screen of the DIM weight comparator;

FIG. 6 is an illustration of an exemplary threshold percentage setup screen of the DIM weight comparator;

FIG. 7 is an illustration of an exemplary DIM comparison screen of the DIM weight comparator;

FIG. 8 is an illustration of an exemplary DIM comparison screen of the DIM weight comparator indicating that a dimensional weight calculation is necessary after the comparison has been made; and

FIG. 9 is an illustration of another exemplary DIM comparison screen of the DIM weight comparator indicating that a dimensional weight calculation is unnecessary after the comparison has been made.

### DETAILED DESCRIPTION OF THE EXEMPLARY EMBODIMENT(S)

The present inventive concept will now be described more fully hereinafter with reference to the accompanying drawings, in which some, but not all possible embodiments of the invention are shown. Indeed, these inventions may be embodied in many different forms and should not be construed as limited to the embodiments set forth herein.

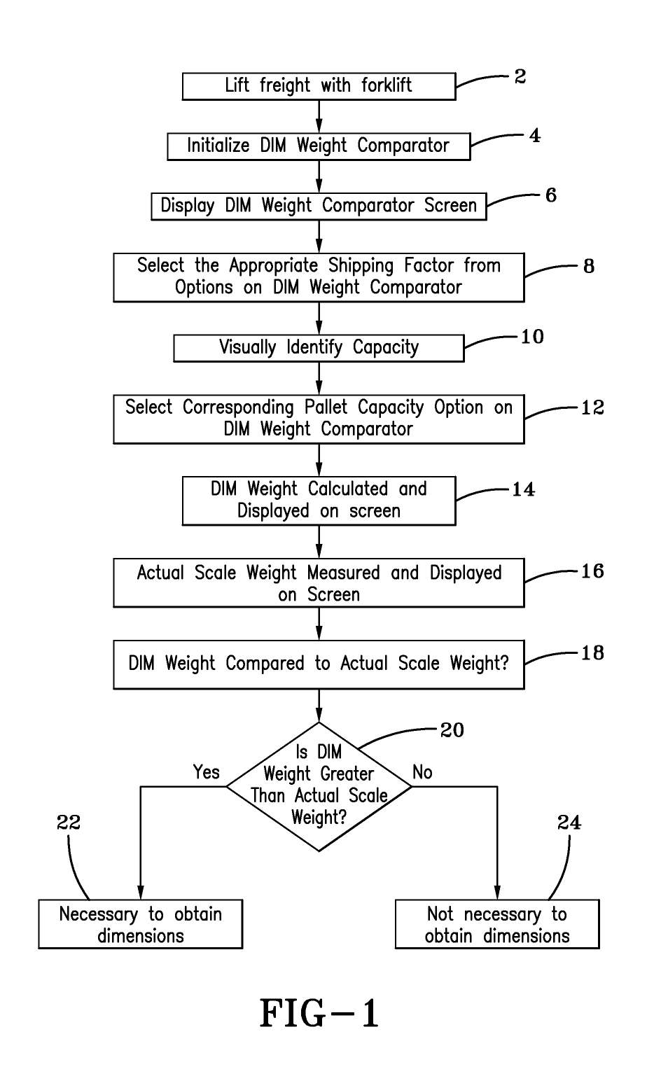

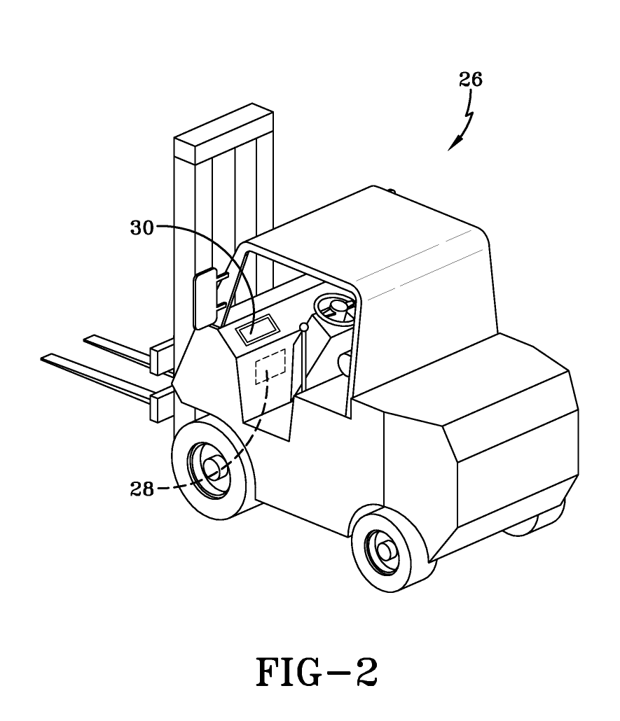

FIG. 1 diagrammatically illustrates an exemplary embodiment of a system and method for weighing and determining whether a dimensional measurement of freight is necessary. In FIG. 1, freight (such as palletized freight) is lifted by a forklift 2 having a forklift scale for providing the weight of the freight on the forks. Once the freight is resting on the forks of the forklift, the DIM weight comparator is initialized 4. The DIM weight comparator may be initialized automatically when a weight is applied to the forks of the forklift or, in other exemplary embodiments, the operator of the forklift may manually initialize the DIM weight comparator. After initialization, the DIM weight comparator screen is displayed 6 to the operator of the forklift. The display 30 (such as the display shown in FIG. 2) for the DIM weight comparator may be integrated into the instrument panel of the forklift. In other exemplary embodiments, the display 30 may be located anywhere on or in the forklift that provides for good visualization and manipulation by the operator.

In use of the DIM comparator, an appropriate shipping factor may be selected 8. The system may allow the operator to select between a preprogrammed selection of shipping factors or, in other exemplary embodiments, a single shipping factor may be preprogrammed into the system during setup, thereby further limiting the potential for human error. A visual inspection of the freight may be conducted 10 to identify the percent of the pallet's maximum capacity that is used. After the visual inspection is made, the operator selects the corresponding capacity option on the DIM weight comparator 12.

The DIM weight comparator then calculates and displays the theoretical DIM weight 14 by using the selected shipping factor and the used capacity of the pallet. Although described using palletized freight, one of ordinary skill in the art would understand that exemplary embodiments of the resent invention may be used with other shipping devices, such as boxed freight and other shipping containers. While the freight is supported by the forklift, the actual weight of the freight is determined and typically also displayed to the operator 16. The DIM weight comparator, after determining the theoretical DIM weight and the actual scale weight, compares the two weights 18. The comparison determines whether the theoretical DIM weight is greater than the actual weight 20 of the freight. If the theoretical DIM weight is greater than the actual scale weight of the freight, the DIM weight comparator instructs the operator to obtain a dimensional measurement 22 of the freight. If the theoretical DIM weight of the freight is less than actual scale weight of the freight, the DIM comparator notifies the operator that a dimensional determination is unnecessary 24 and the operator may proceed with loading the freight.

FIG. 2 illustrates an exemplary manner in which a forklift 26 may be equipped to implement a system and method described herein. In this embodiment, the CPU 28 of the DIM weight comparator may be integral to forklift 26. The CPU 28 may be located in the dash of the forklift 26 as illustrated in FIG. 2. In other exemplary embodiments, the CPU 28 may be located anywhere on the forklift allowing existing forklifts to be modified to accommodate the system and method described herein, or the CPU may be located in a DIM comparator housing. The CPU unit 28 may include a data storage unit for storing data related to maximum shipping device capacity, percent of maximum shipping device capacity used, shipping factors values, and a threshold percentage, and a processing unit for comparison of DIM weight versus actual weight. The CPU 28 may also be equipped with a display device 30, such as a LCD display, which may be conveniently located for displaying information to the operator of the forklift 26.

In the embodiment shown in FIG. 2, the display 30 is integral with the dash of the forklift 26 in view of the forklift operator. In other exemplary embodiments, the display 30 may be located at any other position in or on the forklift 26 that allows viewing by the forklift operator. Thus, in some embodiments, the DIM comparator may be a housed device that is attachable to the forklift. The display 30 may also function as an input device for receiving commands from the forklift operator. For example, the display 30 may incorporate touch screen technology, or it can be equipped with keys or buttons that allow the forklift operator to setup and operate the DIM weight comparator.

The DIM weight comparator may also be in communication with the scale mechanism (e.g., load cell) of the forklift 26. In this manner, as the scale of the forklift 26 weighs the freight, the actual scale weight of the freight may be transmitted to the DIM weight comparator. It should be understood that this illustration represents only one way that the system and method described herein can be implemented. For example, in one alternative embodiment, the CPU 28 and display 30 may be integral to a crane or other lifting device used in the shipment of freight. Communications between the CPU 28, display 30, and load cell may occur, via a wired or wireless connection. In still other exemplary embodiments, the DIM weight comparator may be integrated and communicate with existing systems such as invoicing, tracking, and other systems associated with freight shipping to increase overall efficiency. Furthermore, although described in relation to a forklift, other devices that may be associated with weighing operations, such as static weighing platforms and conveyor belts, are contemplated for use in conjunction with a DIM weight comparator described herein.

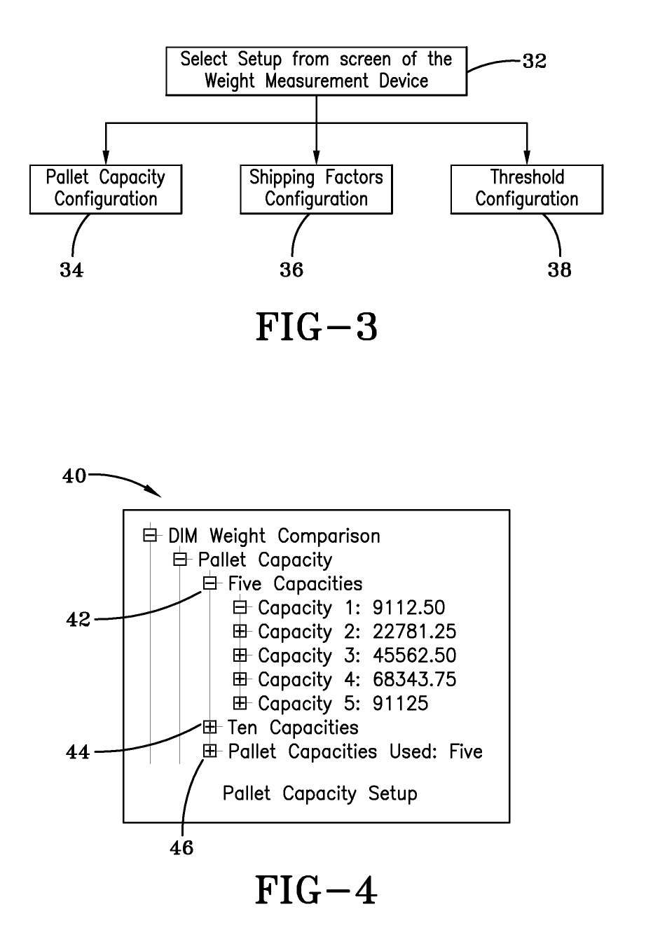

FIG. 3 diagrammatically illustrates an exemplary configuration procedure of the DIM weight comparator. To initialize the setup of the DIM weight comparator a setup button is selected 32 on the display 30. The DIM weight comparator may then provide visual prompts on the display 30 to guide the operator through configuration of the pallet capacity 34, shipping factor 36, and threshold 38. The pallet capacity 34 is used to determine the freight's volume as it relates to the pallet's maximum capacity at various stages (e.g., full capacity, three-quarters capacity, half capacity, etc.). In the exemplary embodiment of the pallet capacity selection screen 40 illustrated in FIG. 4, the operator is presented with two options for pallet capacity; five 42 and ten 44. “Five” provides 5 pallet capacity possibilities and “Ten” provides 10 pallet capacity possibilities. For example, a pallet's maximum capacity is determined to be 91,125 cu. in., and five pallet capacities are used to identify the freight's volume at various stages identified in 25% increments. In this scenario, the values set for five capacity options would be as follows:
Capacity 1 =9112.50 (10% or less)
Capacity 2 =22781.25 (25%)
Capacity 3 =45562.50 (50%)
Capacity 4 =68343.75 (75%)
Capacity 5 =91125 (100%)

Using this same pallet capacity example, ten pallet capacities could be identified in 10% increments; whereas Capacity 10 would equal 91125 (100%), Capacity 9 would equal 82012.50 (90%), Capacity 8 would equal 72900 (80%), and so on. The pallet capacity selection screen 40 also provides a visual indication to the operator of the currently selected pallet capacity setting 46. The pallet selection screen 40 provides a means for the operator to change the values assigned to the pallet capacity for each capacity setting for a pallet having a maximum either greater or less than 91125 cu. in. Other pallets may have other volume capacities. Additionally, the volume of this exemplary pallet, as well as other pallets, may be expressed in alternate units such as cubic feet, cubic meters, etc.

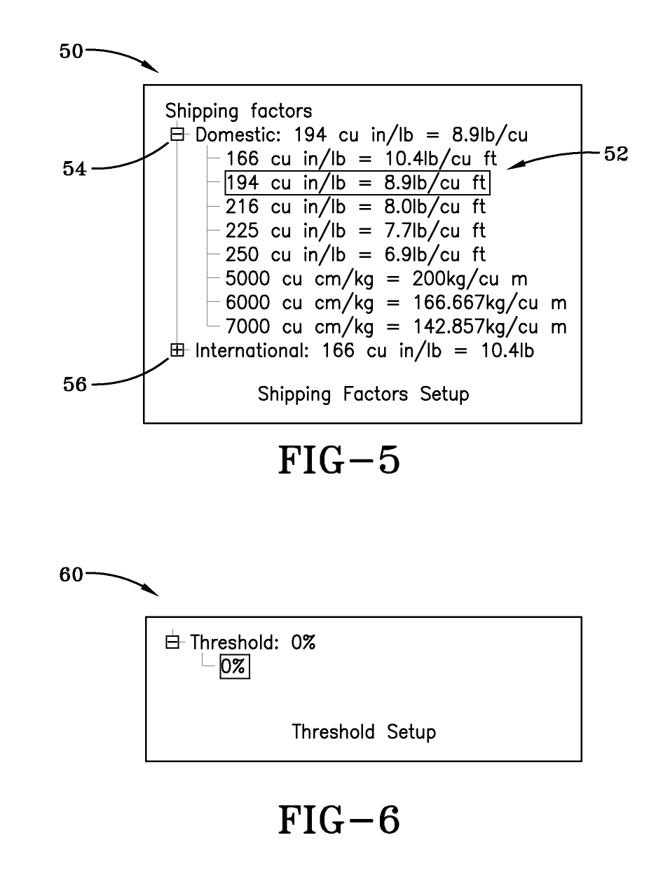

The shipping factor represents the conversion from volume to weight. The pallet capacity divided by the shipping factor determines the DIM weight. The shipping factor setup is accomplished through the shipping factor setup screen 50 on the display 30, as illustrated in FIG. 5. The shipping factor setup screen 50 allows the operator to select from preprogrammed shipping factors 52 for both domestic 54 and international 56 shipping. If different shipping factors are selected for domestic 54 and international 56 shipping the operator may need to manually select which shipping factor to use on the DIM weight comparison screen 70 (shown in FIG. 7). In other exemplary embodiments, multiple shipping factors may be selected for each domestic 54 and international 56 shipment, depending on the freight, the customer, or other factors.

The threshold is a percentage (%) value that indicates when freight should be taken to the pallet measuring system. A value of zero percent (0%) indicates that the DIM weight must be greater than or equal to the actual weight. A value greater than zero percent (0%) indicates that if the DIM weight plus the threshold value is greater than or equal to the actual weight, then the pallet should be taken to the pallet measuring system. This allows the operator to program in a buffer to ensure that no time is wasted taking freight to the pallet measuring system unnecessarily. The threshold value may be entered by the operator on the threshold setup screen 60, illustrated in FIG. 6, or may be pre-programmed and/or fixed.

Although the setup screens 40, 50, and 60 are shown in node tree from, other visualizations may be utilized, such as tiled displays or drop down boxes. In still other exemplary embodiments the configuration and manual selection by the operator may be eliminated. In these alternative embodiments the pallets of freight may have bar codes or RFID chips. For embodiments where a bar code is utilized the forklift 26 may have a bar code scanner, in communication with the CPU 28, the scanner positioned so as to read the bar code on the pallet of freight or a hand-held unit that may be so positioned. The bar code may provide the DIM weight comparator with values for the maximum pallet capacity, shipping factor, and threshold information, eliminating the need to manually configure the DIM weight comparator.

In exemplary embodiments utilizing RFID chips, the forklift 26 may be equipped with a RFID reader (which may be a hand-held reader) in communication with the CPU 28. Like the bar code, the RFID chip may provide the DIM weight comparator with the values for the maximum pallet capacity, shipping factor, and threshold information, again eliminating the need to manually configure the DIM weight comparator. These embodiments would also eliminate potential human error associated with manual entry related to the shipping factor during operation.

As discussed above, during use of the DIM weight comparator the operator may be required to visually identify the pallet capacity 10, and select the corresponding pallet capacity option on the DIM weight comparator 12. The DIM weight comparator display 30 provides a DIM weight comparison screen 70 to the operator. The DIM weight comparison screen 70 preferably displays the actual scale weight 72 of the freight as measured by the forklift 26. A prompt 74 may also be provided to guide the operator to the next step in the DIM weight comparison, such as selecting the correct pallet capacity based on a visual inspection.

Pallet capacity buttons 76 are preferably provided to allow the operator to select the correct pallet capacity based on a visual inspection. Each of the pallet capacity buttons 76 may represent a different value selected on the pallet capacity setup screen 40, during initial configuration. In this particular example, the pallet capacities are identified by pie graphs indicating the percent of the pallet filled with freight. Other pallet capacity indicators (graphics, etc.) may be employed in other embodiments. During this step in the process, the system may also allow the operator to select between different shipping factors, such as those configured for domestic and those configured for international, such as by using a shipping factor selection button 78. A “Close”, “OK”, etc. button 79 may also be provided to allow the operator to turn off or reset the DIM weight comparator. Other screen configurations are also possible, as would be understood by one of skill in the art.

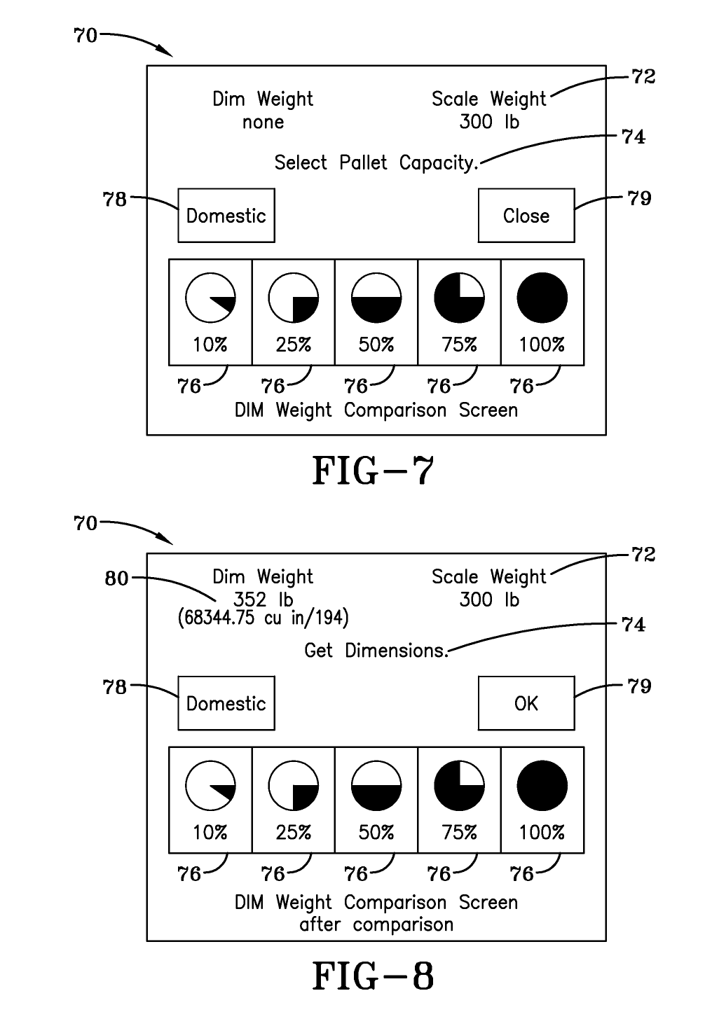

Once the operator has selected the proper pallet capacity, the proper shipping factor, and the DIM weight comparator has compared the DIM weight to the actual scale weight, the DIM weight comparator may display the theoretical DIM weight 80, as illustrated in FIG. 8. Again, a prompt 74 may be provided to instruct the operator on the proper course of action. Since the DIM weight 80 is greater than the actual scale weight 72 in this case, the prompt 74 instructs the operator to continue to the dimensional measuring system. The prompt could also instruct the operator to measure the freight by hand. If the DIM weight 80 was less than actual scale weight 72, the prompt 74 would instruct the operator to proceed with loading the freight.

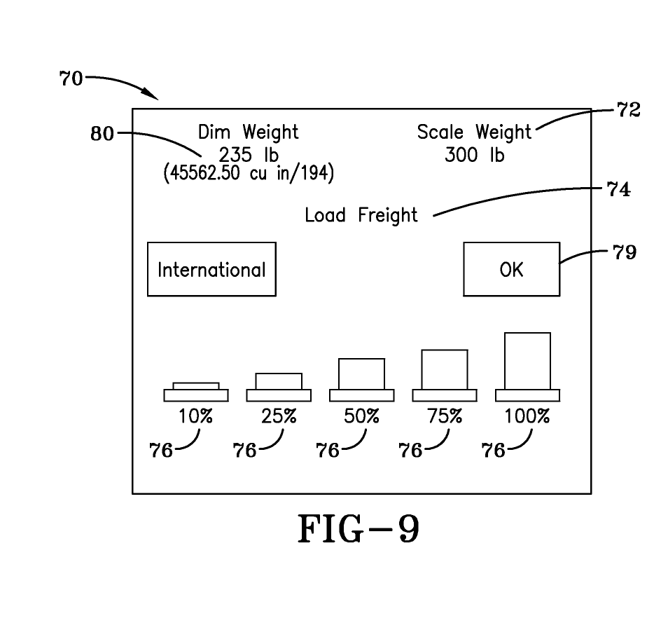

FIG. 9 illustrates another exemplary embodiment of a DIM weight comparison screen 70. In this exemplary embodiment, the pallet capacity buttons 76 are represented by depictions of pallets having freight thereon. Additionally, in this depiction the DIM weight 80 is less than the actual scale weight 72, thus the prompt 74 instructs the operator to continue loading the freight without the need to measure the dimensions of the freight. Thus, one of ordinary skill in the art would understand that information displayed on the DIM weight comparison screen 70 may be represented in a variety ways, and the exemplary embodiments do not serve to limit these variations.

While certain embodiments of the invention are described in detail above, the scope of the invention is not considered limited by such disclosure, and modifications are possible without departing from the spirit of the invention as evidenced by the following claims:

What is claimed is:

1. A system for determining the need for dimensional weighing, comprising:
a forklift equipped for lifting freight;
a weighing device associated with the forklift for obtaining the weight of freight lifted by said forklift;
a DIM weight comparator in association with said forklift and in communication with said weighing device, said DIM weight comparator comprising:
a data storage unit, the data storage unit storing values associated with pallet capacity, shipping factors, and thresholds;
a processing unit, the processing unit comparing an actual weight of said piece of freight to a theoretical DIM weight;
an input/output device in association with said data storage unit, processing unit and said forklift, said input/output device allowing an operator to select data stored on the data storage unit and outputting a comparison between said theoretical DIM weight and said actual weight based on operator selected data; and
a prompt directing said operator as to whether a dimensional measurement is necessary.

2. The system of claim 1, wherein said weighing device includes a load cell mounted to said forklift for sensing the weight of the piece of freight.

3. The system of claim 1, wherein said input/output device is a display.

4. The system of claim 3, wherein said display is a touch screen LCD.

5. The system of claim 1, wherein said prompt is a visual indication on said input/output device.

6. A method for determining the need for dimensional weighing, comprising:
equipping a forklift with a weighing device and a DIM weight comparator and a display, wherein said weighing device and said display are in communication with said DIM weight comparator and wherein said display is associated with said forklift and operates as the input/output device for said DIM weight comparator;
lifting freight to be weighed with said forklift;
measuring the actual weight of said freight using said weighing device;
initializing said DIM weight comparator;
selecting an appropriate shipping factor from options displayed by said DIM weight comparator;
visually inspecting said freight to determine a percent of capacity;
selecting said percent of capacity from displayed capacities on said display;
calculating a theoretical DIM weight based on the selected shipping factor and percent of capacity;
displaying said theoretical DIM weight to an operator through said display;
comparing said theoretical DIM weight to the actual weight; and
prompting said operator on whether a dimensional weighing operation is necessary based on said comparison of the theoretical DIM weight to the actual weight of the freight.

7. The method of claim 6, wherein said weighing device includes a load cell.

8. The method of claim 6, wherein said display is a LCD having a touch screen feature.

9. A method for determining the need for dimensional weighing, comprising:
providing a DIM weight comparator;
weighing freight to determine the actual scale weight of said freight, wherein said freight resides on a shipping device;
selecting a shipping factor;
determining the maximum capacity of said shipping device in volume per weight;
determining a percent of shipping device maximum capacity occupied by said freight;
projecting a theoretical dimensional weight based on the selected shipping factor and the determined percent of shipping device maximum capacity occupied by said freight;
comparing the theoretical dimensional weight of said freight to the actual scale weight of said freight; and
prompting an operator on whether a dimensional weighing operation is needed based on the comparison of the theoretical dimensional weight of said freight to the actual scale weight of said freight, wherein when the theoretical dimensional weight is greater than the actual scale weight a dimensional weighing operation is advised.

10. The method of claim 10, wherein said DIM weight comparator includes:
an input/output device; and
a CPU unit in communication with said input/output device.

11. The method of claim 11, wherein said input/output device is a touch screen display.

12. The method of claim 10, wherein said shipping device is a pallet.

13. The method of claim 10, further comprising inputting the maximum capacity of said shipping device into said DIM weight comparator.

14. The method of claim 10, further comprising displaying to an operator said comparison of the theoretical dimensional weight of said freight to the actual scale weight of said freight.

15. The method of claim 10, wherein determining the percent of shipping device maximum capacity occupied by said freight is conducted through visual inspection by an operator.

16. The method of claim 10, further comprising inputting said percent of said shipping device maximum capacity occupied by said piece of freight by way of said input/output device.
